(19) United States
(12) Patent Application Publication
(10) Pub. No.: US 2003/0117374 A1
(43) Pub. Date: Jun. 26, 2003

(54) Portable electronic device with rear-facing touch typing keyboard

(76) Inventor: John Edwin McCloud, Wickliffe, OH (US)

Correspondence Address: Eugene E. Clair, 30400 Kristin Court, Willoughby Hills, OH, 44092, US

(21) Appl. No.: 10/218,806

(22) Filed: Aug. 14, 2002

Related U.S. Application Data
(62) Division of application No. 09/567,184, filed on May 9, 2000, now abandoned.

(51) Int. Cl. G09G 5/00

(52) U.S. Cl. 345/168

(57) ABSTRACT

An apparatus (20) for data entry to an electronic device includes a housing (21) having a front facing surface (22) and a rear facing surface (24). A keyboard (62, 76, 130, 200) provides for a plurality of multifunction alphanumeric keys on the rear-facing surface (24) that are arranged for data entry using a standard two handed touch typing method while the apparatus is held in the hands (34, 36) of an operator. A display (72) may be included on the front facing surface (22).

This application is a division of co-pending U.S. patent application Ser. No. 09/567,184 filed May 9, 2000.

### BACKGROUND

The present invention relates to portable electronic devices including communications, internet access, data entry or computing devices and is particularly related to an apparatus for alphanumeric data entry to portable electronic devices.

Portable electronic devices and computers are used in ever expanding roles to organize personal and professional contacts as well as facilitate management of schedules, data entry, data processing, data display, telecommunications, computation and purchases. These devices continue to become increasingly important tools in our working and personal environments.

As portable systems continue to become smaller, more sophisticated, complex and more powerful, the functionality and utility of these systems has expanded the data entry requirements for these smaller portable devices. Users of these devices need to have sophisticated data entry and communications capability to access the well developed functions and features available in current personal and business applications and communications systems. Simple numeric entries or calculator type alphanumeric data entry is not sufficient for the data entry requirements of present systems. In addition to the increasing data input needs, the use of such portable devices is spreading to yet a wider segment of both the business and general population.

In an effort to maintain the portability of these devices and provide for full data entry capabilities, keyboards have been miniaturized and non-standard data entry systems have been developed. Miniaturized keyboards have small keys, are cramped and difficult to use. Control keys are numerous and comfortable or reflexive use of these devices is usually difficult to acquire. These factors can lead to data entry errors from inadvertent or mistaken character entry. Some keyboards are transported in a portable configuration and are convertible to an operative configuration. For example, the keyboard may unfold or slide out of a laptop device.

Some examples of non-standard data entry devices include systems configured for one handed operation, chordic, microwriting and sequential keystroke techniques for individual character data entry. The disadvantage of non-standard data entry systems is that their use is unfamiliar to the majority of the general population of end users unless they acquire specialized training to develop proficiency. For example, with a chordic type of data entry device, characters are generated by actuating one or more keys simultaneously in different combinations. Many single handed data entry devices use a chordic method to provide alpha numeric data entry characters. Stenotype uses a two-handed chordic method to mechanically produce a shorthand record. Yet another character generation method is a sequential technique. In this method, keys are actuated sequentially to generate a single character. Some of these non-standard data entry devices and methods require a longer period of time to enter the same amount of data since only one hand is used or many of the characters require a plurality of series keystrokes to register a character signal. This can slow the data entry process and use of the specific application.

Information relevant to attempts to address the problem of providing portable full alphanumeric data entry capability for portable electronic devices can be found in U.S. Pat. Nos. 5,941,648; 5,841,374; 5,790,103; 5,627,566; 5,500,643; 5,481,263; 5,432,510; 5,361,083; 5,137,384; 4,791,408; 4,324,976 and 4,042,777. However, each of these references suffers from one or more of the following disadvantages: (i) requires additional training for the operator to master a non-standard data entry skill, (ii) keyboard is cramped, (iii) keys are small, (iv) system is not two handed touch typing capable while device is held (v) non-standard systems take longer to enter data (vi) are separate units that must be carried and connected to the electronic device (vii) devices have a large number of control keys to obtain full data input functionality, (viii) increased data entry errors, and (ix) not easily portable.

For the foregoing reasons, as usage of more versatile and capable portable electronic devices and applications spreads to a wider segment of the population, a need exists to provide end users a data input apparatus that permits full and complete use of the devices. It is desirable to capitalize on data entry skills that already reside within the present capabilities of the majority of end users. It is also desirable to have full use of these systems without having to learn difficult or non-standard key coding techniques.

There is a need for a data entry apparatus that has full data entry capabilities for use with lightweight portable computing and communications devices that provides a full character set and does not require the operator to learn a new skill, other than standard touch typing skills used for standard operation of conventional desktop or notebook computers having standard keyboards.

In addition, to maintain the advantages of portability and increase the end users access to applications and communications systems, it is desirable that such portable devices be adapted to be held by the operator while data entry is being carried out. It is also desirable to provide such full data entry capabilities using a reduced number of multifunction keys while retaining the finger assignments associated with standard touch typing skills. Such a device increases the flexibility and ease of use for portable electronic devices and telecommunications/Internet interfaces.

### SUMMARY OF THE INVENTION

The present invention is directed to a portable computing or data entry device that satisfies the need to provide an alphanumeric data entry keyboard which is able to be utilized while the portable device is being held by an operator using two handed touch typing method. The present invention does not require the operator to learn a new or non-standard touch typing skill. An apparatus in accordance with one embodiment of the present invention includes an electronic computing or data entry device having a housing with a front-facing surface and and a rear facing surface. A keyboard comprises a plurality of alphanumeric keys on the rear-facing surface. The keys are arranged into two groups for two handed touch typing when the apparatus is held by an operator. A data channel is provided for input/output communication with the keys.

In accordance with a more limited aspect of the present invention, a display is located on the front facing surface. In a more limited aspect of the present invention, a processor is included within the housing to run the personal and business applications, calculations and communications commonly found in portable electronic devices.

In accordance with another limited aspect of the present invention, the keys are arranged for providing a standard touch typing finger assignment. In a more limited aspect of the present invention, the standard keyboard arrangement is a QWERTY arrangement.

In accordance with another limited aspect of the present invention, the apparatus includes a reduced number of multifunction keys arranged located on the rear facing surface of the computing device. In accordance with a more limited aspect of the invention, the multifunction keys are arranged into two groups. The multi function keys provide at least two different character signals and may provide six or more. Multiple actuation of the key is used to generate some of the characters with the multifunction keys

In accordance with another aspect of the present invention, the keys on the rear surface are mounted on angled portions.

In accordance with another aspect of the present invention the apparatus is capable of being connected to any of a number of communications systems including a telecommunications system, a fiber optic system, a cellular communications system, a satellite communications system, a cable television system, a computer system, an Internet access system and an infra red communications system.

In accordance with yet another aspect of the invention, a method is provided for entering data into a hand-held electronic device having a front-facing surface and a keyboard on an opposite rear-facing surface. The method comprises the steps of holding the electronic device in both hands, placing the digits of the right and left hand on respective sets of keys located on the rear facing surface and actuating the keys according to a standard two handed touch typing method to produce alphanumeric characters for data entry.

In accordance with a more limited aspect of the invention, the method includes the step of viewing a human readable display while actuating the keys. In accordance with a yet more limited aspect of the invention the method includes the step of holding the display while viewing the display and actuating the keys.

One advantage of the present invention is that full alphanumeric data entry is possible with portable hand held electronic devices while the device is being held by the operator.

Another advantage of the present invention is that the data entry method uses a standard two handed touch typing skill commonly known to many end users.

Yet a further advantage of the present invention is that the full alphanumeric data entry is accomplished using a reduces number of multifunction keys.

The present invention provides the foregoing and other features hereinafter described and particularly pointed out in the claims. The following description and accompanying drawings set forth certain illustrative embodiments of the invention. It is to be appreciated that different embodiments of the invention may take form in various components and arrangements of components. These described embodiments being indicative of but a few of the various ways in which the principles of the invention may be employed. The drawings are only for the purpose of illustrating a preferred embodiment and are not to be construed as limiting the invention.

### BRIEF DESCRIPTION OF THE DRAWINGS

The foregoing and other features and advantages of the present invention will become apparent to those skilled in the art to which the present invention relates upon consideration of the following detailed description of a preferred embodiment of the invention with reference to the accompanying drawings, wherein:

FIG. 1 is a front plan view of a keyboard in accord with features of an embodiment the present invention;

FIG. 2 is a rear plan view of a keyboard in accord with features of an embodiment the present invention;

FIG. 3 is a front plan view of another embodiment in accord with features of the present invention;

FIG. 4 is a rear plan view of another embodiment in accord with features of the present invention;

FIG. 5 is a cut away schematic representation of an embodiment of a multifunction key along the line 5-5 suitable for use in the keyboard of FIG. 4;

FIG. 6 is a front plan view of another embodiment in accord with features of the present invention;

FIG. 7 is a rear plan view of another embodiment in accord with features of the present invention;

FIG. 8 is a rear plan view of another embodiment in accord with features of the present invention;

FIG. 9 is a top view of another embodiment in accord with features of the present invention; and

FIG. 10 is a perspective view of another embodiment of an apparatus incorporating features of the present invention.

### DETAILED DESCRIPTION

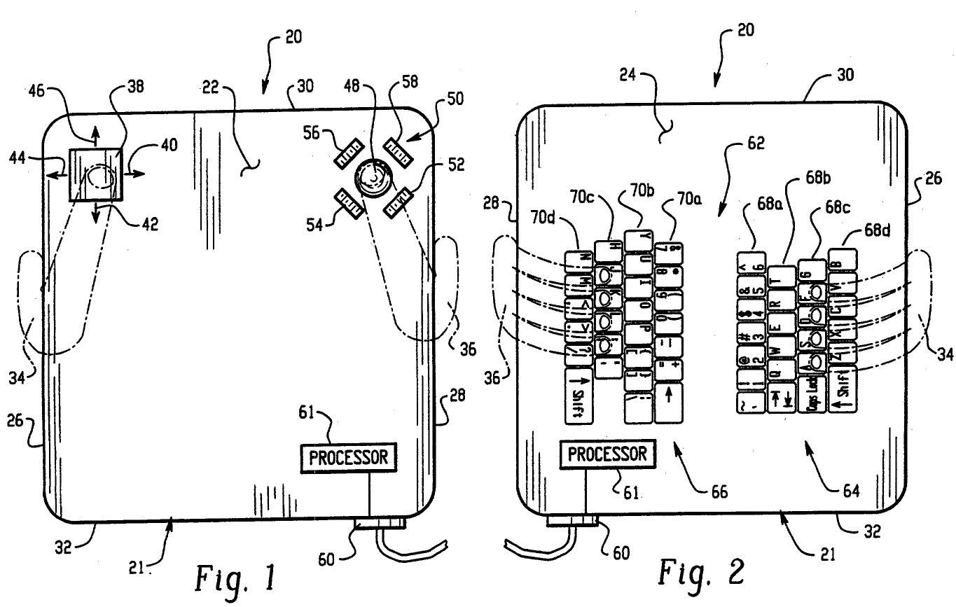

With reference to FIGS. 1 and 2, an electronic apparatus 20 has a housing 21 which includes a front facing surface 22 and a rear facing surface 24. A modified QWERTY keyboard 62 is located on the rear facing surface 24. The front surface 22 and rear surface 24 are preferably connected with side walls 26, 28 a top wall 30 and bottom wall 32. Alternatively, the front surface 22 and rear surface 24 may be connected directly to each other with a tapered or curved transition at their edges thereby effectively eliminating the discrete walls 26, 28, 30 and 32. The apparatus 20 is shown held by a left hand 34 (shown in phantom) of an operator and a right hand 36 (also shown in phantom).

The front surface 22 includes a multi-function key 38 for operation with the left thumb of the operator while the apparatus 20 is held by the operator. Preferably, the key 38 can be actuated, in at least four directions, to provide an electrical signal to control functions of the keyboard as indicated by the arrows 40, 42, 44, 46. For example, movement of the key 38 with the thumb in the direction of arrow 40 provides a space bar command. Movement of the key 38 in the direction of arrow 42 provides an enter command, the direction of 44 provides a back space command and the direction of arrow 46 provides and up arrow command. Alternatively, rather than moving the key in the direction of the arrows 40-46, each of the sides of the keys, as well as the corners, may be depressed to provide a signal. It is also possible that more than four commands can be provided from the key 38 as well as a different selection of commands, depending on the specific configuration of the key 38.

A mouse control 48 is located on the front face 22 to be operable by the right thumb of the operator when the apparatus 20 is held. The mouse control 48 may be one of any suitable devices known in the art for controlling a mouse on a display. For example, a track ball, touch pad or joystick type control may be used. In addition to the mouse control 48, various command keys 50 are included for operation by the right thumb. A single click button 52, a double click button 54, a control key 56 and a right mouse button 58 are examples of command keys that are provided.

An input/output port 60, located on the bottom wall 32, serves as a data channel and connects the apparatus 20 to provide keyboard character signals to a data processing system or portable electronic device (not shown). Alternatively, the apparatus 20 includes its own internal processor resource 61 for data processing, communications or other personal and business end user applications. When the apparatus 20 is configured in this manner, the keyboard 62 is in data communication with the internal processor through suitable internal components (not shown). This permits the I/O port 60 to be in data communication with the processor 61 and serve as a communications interface to network the apparatus 20 or connect it to an external monitor (not shown), a communications system through an appropriate communications interface such as a modem, a fiber optic system or cable television system. These systems and applications may be accessed through connection to portable electronic devices such as personal digital assistants, cellular and satellite phones, personal organizers, portable computers, calculators and the like.

The sophisticated personal and business applications of today are more effectively utilized with the availability of a full range of keyboard characters and yet maintain the desired size and portability. In addition, it is desirable to provide a standard type of data entry method that is presently known and used by a large number of end users without requiring additional training for specialized data entry methods. In particular, it is desirable to utilize a data entry method that relies on standardized two handed touch typing methods.

Conventional two-handed typewriter or data entry keyboards generate a single character for each single actuation of the key. Control, or shift, keys may change the character signal from lower case to upper case or from a numeric character to another standard symbol. The keyboards shown and described in the various embodiments of the described devices utilizing features of the present application illustrates implementations of, or modifications, that capitalize on using similar operator finger assignments for a standard QWERTY keyboard for the English alphabet as used in the United States. Whether a reoriented standard QWERTY keyboard or a modified structure, the finger assignments for generating a particular character signal remains similar to the QWERTY configuration such that the touch typing skills necessary for operation of the portable apparatus of the present invention is easily transferred by any individual having standard two handed touch typing skills. It is to be appreciated that the keyboard can be configured to provide character signals for any alphabet arrangement of any language with the standard keyboard configuration for the particular country or language.

In the present invention, a new and different structure allows for touch typing data entry to satisfy the sophisticated data entry requirements of current portable personal and business computer and communications applications. In one embodiment employing features of the present invention, the rear surface 24 includes the modified QWERTY keyboard 62. The modified keyboard 62 includes a first group of keys 64 located on one half of the rear surface 24 and a second group of keys 66 located on the other half of the rear surface 24.

The first group of keys 64 includes the keys that conventionally are operated by the left hand 34 in a standard touch typing method. In this embodiment, there are a plurality of rows of keys 68a, 68b, 68c and 68d. Each row is arranged such that when the apparatus 20 is held with the fingers of the left hand 34 extending around the side wall 26, the keys normally actuated by the left little finger are closest to the bottom wall 32. The keys for the ring finger assignment are next, followed by those actuated by the middle finger until the keys normally actuated by the left index finger are located nearest to the top wall 30. The row of keys 68d is located nearest the side wall 26 and includes the letters Z,X,C,V,B. The row of keys 68a is located furthest from the side wall 26 toward the middle of the rear surface.

The second group of keys 66 includes the keys that conventionally are operated by the right hand 36 in a standard touch typing method. In this embodiment, there are a plurality of rows of keys 70a, 70b, 70c and 70d. Each row is arranged such that when the apparatus 20 is held with the fingers of the right hand 36 extending around the side wall 28, the keys normally actuated by the right little finger are closest to the bottom wall 32. The keys for the ring finger assignment are next, followed by those actuated by the middle finger until the keys normally actuated by the right index finger are located nearest to the top wall 30. The row of keys 70d is located nearest the side wall 28 and includes the letters /,(period.),(comma,),M,N. The row of keys 70a is located furthest from the side wall 28 toward the middle of the rear surface.

The portable electronic apparatus 20 is held with the thumbs on the front surface 22 and the fingers extending around the side walls 26, 28 to the keyboard 62 on the rear surface 24. The fingers of each hand 34, 36 are placed on their respective groups of keys 64, 66. While the operator is holding the apparatus 20, the keyboard 62 is actuated to provide full feature data entry using two handed touch typing skills associated with any standard keyboard layout, such as the QWERTY arrangement used in the United States. Locating the keyboard 62 on the rear surface 24 permits two handed touch typing while the apparatus 20 is held with the front surface facing the operator.

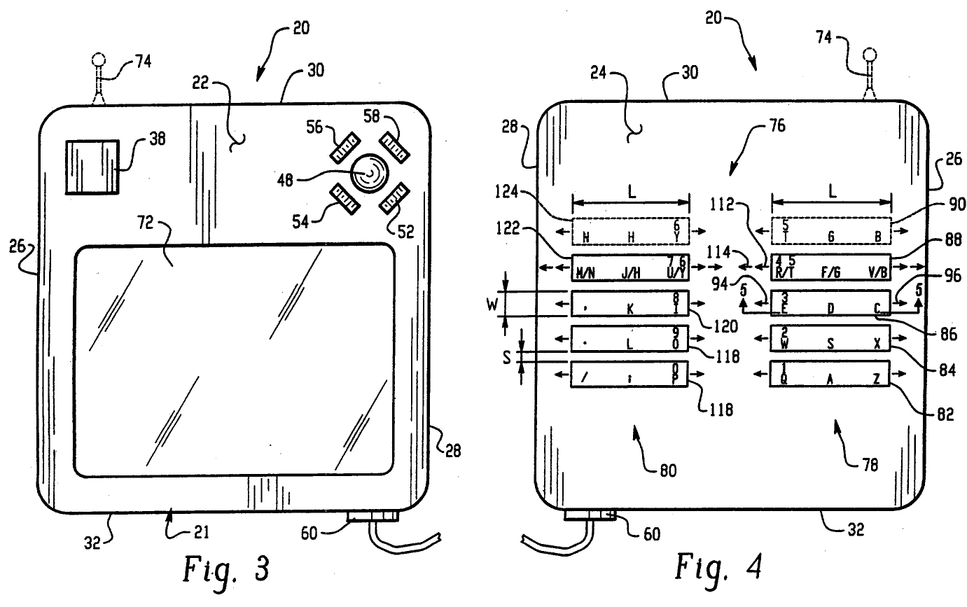

Referring now to FIGS. 3 and 4, a preferred embodiment of the present invention is described. Elements common with other described embodiments of the invention will have common element numbers throughout the description. The front surface 22 includes a conventional display 72, such as an LCD, flat panel display, touch screen or other suitable display for displaying data input from a keyboard or output from any of the applications used in a portable electronic device. Preferably, a suitable processor and other internal buffers, memory, and suitable computer architecture and devices (not shown) are included within the housing 21 to provide for a operative personal or business portable electronic device. Optionally, an antenna 74 is located on the apparatus 20 to provide input/output access for mobile telecommunications, whether cellular, satellite or alternatively an optical communications interface is included. Such a communications interface provides direct communications to computer resources connected to existing telecommunications systems as well as for Internet access.

The rear surface 24 has a keyboard 76 that includes a first group of keys 78 located on one half of the rear surface 24 and a second group of keys 80 located on the other half of the rear surface 24. Each group of keys includes a plurality of multifunction keys, preferably four keys. Each multifunction key is actuatable to provide at least two different characters, and preferably is actuatable to provide three different characters. The groups of multifunction keys are arranged to be actuated such that the generation of characters by an operator will utilize two handed touch typing skills similar to those required for a standard QWERTY keyboard. This similar functionality is provided by the multifunction capability of the keys.

The multifunction keys have a length “L”, a width “W” and are separated by a space “S”, which may vary between different adjacent keys. The length L, width W and spacing between keys S are selected to such that these dimensions are sufficient to allow for operators having different hand and finger sizes to place their fingers on the keys to suitably actuate the keys, regardless of the operator's hand dimensions. The keys are longer to provide for a single multifunction key size to be effectively used by a wide variety of users.

The first group of keys 78 includes the keys that provide signals for characters conventionally generated by the left hand in a standard touch typing method. In this embodiment, there are a plurality of keys 82, 84, 86 and 88. The group of keys 78 is arranged such that when the apparatus 20 is held with the fingers of the left hand extending around the side wall 26, the characters normally generated by keys of a standard keyboard with the left little finger are generated with the key 82 located closest to the bottom wall 32. Next is the key 84 for the left ring finger assignment, followed by key 86 actuated by the middle finger and finally the key 88 for all of the characters normally actuated by the left index finger, located nearest to the top wall 30. Optionally, a fifth key 90 may be provided to generate character signals for one half of the finger assignments normally executed by the left index finger.

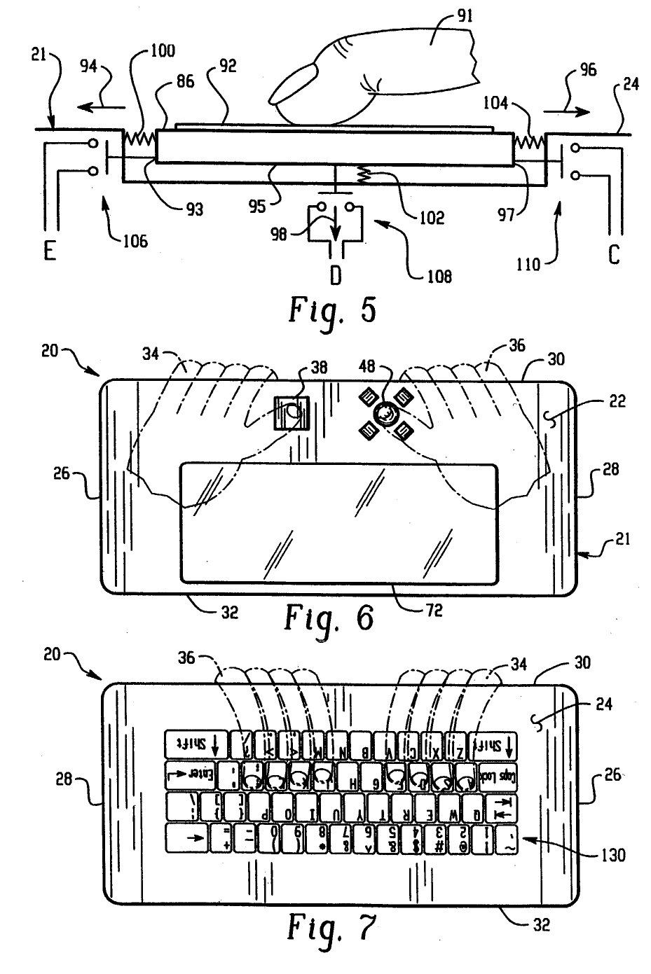

Referring briefly to FIG. 5, the multifunction key 86 is shown schematically illustrating a suitable structure for use with this embodiment of features of the present invention. The key 86 includes a friction surface 92 to suitably engage a middle finger 94 of the left hand of the operator. The surface 92 may be any suitable configuration or material to prevent sliding of the finger on the key when actuating the key in any of the directions described below while allowing for placement of the finger at any point along the length L and width W of the key to maintain the flexibility of allowing for operators of the keyboard 76 having different hand and finger sizes. The key 86 is slidably supported for motion in the direction of arrows 94, 96, 98 within the rear surface 24 of the housing 21. Springs 100, 102, and 104 resiliently bias the key 86 to a home position. A push button contact switch 106 engages one end 93 of the key 86 and electrically connects circuitry to provide a character signal for the letter “E” when the key 86 is slidably moved in the direction of arrow 94 to actuate the signal. A push button contact switch 108 engages a bottom surface 95 and electrically connects circuitry to provide a character signal for the letter “D” when the key 86 is slidably moved in the direction of arrow 98 to actuate the signal. A push button contact switch 110 engages the other end 97 of the key 86 and electrically connects circuitry to provide a character signal for the letter “C” when the key 86 is slidably moved in the direction of arrow 96 to actuate the signal. After actuation of any of the switches 106, 108 and 110, the springs return the key 86 to its home position when the pressure from the finger 94 is released. The other keys in the groups of keys 78, 80 are actuated in similar manner as key 86. Similar direction arrows are shown in FIG. 4 for the characters generated by the other keys.

The key 88 includes the capability to produce all of the character signals for the finger assignment of the left index finger in a standard keyboard layout, such as a QWERTY layout. Preferably, a single actuation of the switch shown by the arrow 112 results in generation of the character R. Actuating the switch twice, within a predetermined time period without actuating any other character signal, shown by the second arrow 114 results in the generation of the character T. Similarly, single actuation of the key in a downward direction results in generating F, double actuation results in generating G. In the last direction for key 88, single actuation of the key produces the character V and double actuation produces the character B. Alternately, the second different character signals T,G, and B can be generated by holding the key 88 in the desired direction for a predetermined time interval greater than that required to generate the first character at each position. Numbers are generated by simultaneous actuation of the control key 56 on the front surface 22 with the right thumb of the operator. For the number four the control key is depressed and the key 88 is actuated once, corresponding to the arrow 112. The number five is generated by depressing the control key 56 and actuating key 88 twice as represented by the arrow 114.

The second group of keys 80 includes the keys that conventionally are operated by the right hand 36 in a standard touch typing method. In this embodiment, there are a plurality of keys 116, 118, 120 and 122. The group of keys 80 is arranged such that when the apparatus 20 is held with the fingers of the right hand extending around the side wall 28, the characters normally generated by keys of a standard keyboard with the right little finger are generated with the key 116 located closest to the bottom wall 32. Next is the key 118 for the right ring finger assignment, followed by key 120 actuated by the middle finger and finally the key 122 for all of the characters normally actuated by the right index finger, located nearest to the top wall 30. Optionally, a fifth key 124 may be provided to generate character signals for one half of the finger assignments normally executed by the right index finger. Alternatively, the optional keys 90 and 124 may be included to provide any other desired characters while keeping all index finger assignments with keys 88 and 122.

During operation, the portable electronic apparatus 20 is held with the thumbs on the front surface 22 and the fingers extending around the side walls 26, 28 to the keyboard 76 on the rear surface 24. The operator can view the display 72 while holding the apparatus 20. The fingers of each hand are placed on their respective groups of keys 78, 80. While the operator is holding the apparatus 20, the keys on the keyboard 76 are actuatable to provide full feature data entry using two handed touch typing skills associated with any standard keyboard layout, such as the QWERTY arrangement used in the United States. Locating the keyboard 76 on the rear surface 24 permits two handed touch typing while the apparatus 20 is held with the front surface 22 and the display 72 facing the operator. The two handed touch typing is accomplished using the reduced number of multifunction keys 82, 84, 86, 88, 116, 118, 120, 122 and optionally including keys 90, 124. The reduced number of multifunction keys allows for a smaller keyboard while permitting full function data entry capability and also providing greater portability.

Referring to FIGS. 6 and 7, another embodiment of an apparatus including features of the present invention is shown. The apparatus 20 is shown with the operators hands 34, 36 extending from the front surface 22 over the top wall 30 to the rear surface 24. The bottom wall 32 is supported by the legs or lap of the operator or on a surface (not shown). The rear surface 24 includes a standard keyboard 130 advantageously adapted to provide for two handed touch typing when the fingers of the operator extend down from the top wall 30 toward the keyboard 130. The full keyboard is arranged with the row of keys Z,X,C,V,B,N,M,(comma,),(period.),/ are located nearest to the top wall 30. The next row of keys includes A,S,D,F,G,H,J,K,L,;,' followed by the row including the letters Q,W,E,R,T,Y,U,I,O,P. Finally, the row including the numeric keys 1,2,3,4,5,6,7,8,9,0, etc, is located nearest the bottom wall 32. This arrangement permits full data entry capabilities using standard keyboard two handed touch typing on the rear surface 24 while permitting the operator to view the monitor 72 during data entry.

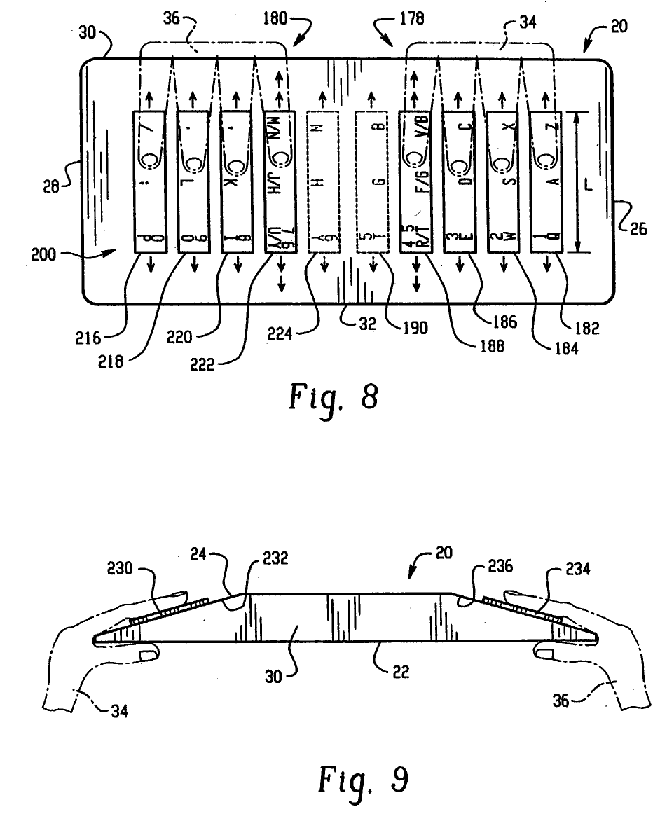

Referring to FIG. 8 another embodiment of an apparatus 20 is shown including features of the present invention. The rear surface 24 has a keyboard 200 that includes a first group of keys 178 located on one half of the rear surface 24 and a second group of keys 180 located on the other half of the rear surface 24. Each group of keys includes at least four multifunction keys. The left hand 34 of the operator will actuate the multifunction keys 182, 184, 186, 188 and optionally 190. The right hand of the operator will actuate the multifunction keys 216, 218, 220, 222 and optionally 224. Each multifunction key is actuatable to provide at least two different characters, and preferably is actuatable to provide three different characters. The groups of multifunction keys are arranged to be actuated such that the generation of characters by an operator will utilize two handed touch typing skills similar to those required for a standard QWERTY keyboard. This similar functionality is provided by the multifunction capability of the keys. In this embodiment, the apparatus 20 is shown with the operators hands 34, 36 extending from the front surface over the top wall 30 to the rear surface 24. The bottom wall 32 is supported by the legs or lap of the operator or on a surface (not shown). The groups of multifunction keys 178, 180 are actuated in a manner similar to that described above with reference to FIGS. 4 and 5. However, in this embodiment, the keys are all arranged side by side with their length L extending from the top wall 30 toward the bottom wall 32.

Referring now to FIG. 9, the apparatus 20 the front face 22 and rear face 24. A first group of keys 230, operable by the left hand 34, are located on an angled portion 232 of the rear face 24. A second group of keys 234, operable by the right hand 36, are located on an angled portion 236 of the rear face 24. The angled portions 232 and 236 of the rear face are adapted to permit comfortable operation of the groups of keys 230 and 234 while the apparatus 20 is held by the operator.

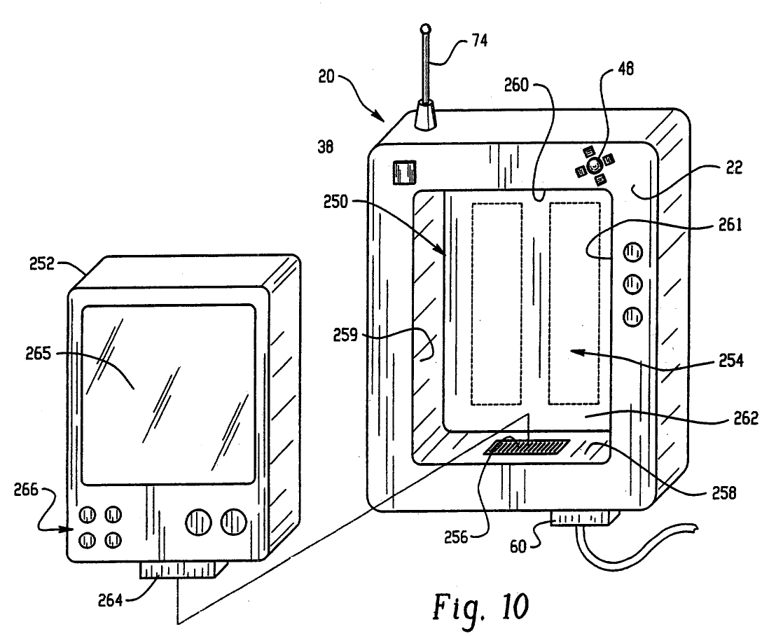

In FIG. 10, the apparatus 20 includes a cavity 250 defined by wall portions 258, 259, 260, 261 and 262. The cavity 250 is advantageously sized and configured to securably retain a portable electronic device 252. The apparatus 20 includes a keyboard 254 (shown in phantom) on its rear face (not visible in this view). The keyboard 254 is arranged according to any of the previously described keyboards illustrating features of the present invention. A terminal 256 is located in the wall portion 258. The terminal 256 is in data communication with the keyboard 254, as well as any other appropriate data communications structures within the apparatus 20.

The portable electronic device 252 includes a terminal 264 suitable for interconnection to the terminal 256 or other suitable data entry apparatus. A display 265 is included in the device 252. Control buttons 266 are used to operate the portable electronic device 252.

The portable electronic device 252 is securably retained in the cavity 250 and the terminals 256 and 264 are connected so that the keyboard 254 on the rear of the apparatus 20 is in data communication with the portable electronic device 252 for data entry. The I/O port 60 is used to connect the entire assembly with any of the communications and computer systems mentioned above, including Internet access. In addition, the antenna 74 is used for interfacing the apparatus 20 and electronic device 252 with communications systems.

While a particular feature of the invention may have been described above with respect to only one of the illustrated embodiments, such features may be combined with one or more other features of other embodiments, as may be desired and advantageous for any given particular application.

From the above description of the invention, those skilled in the art will perceive improvements, changes and modification. Such improvements, changes and modification within the skill of the art are intended to be covered by the appended claims. For example, the primary keyboard used in describing the present invention is the English alphabet QWERTY pattern keyboard. However, the keyboard can be adapted to represent any standard keyboard arrangement for any alphabet or language using touch typing skills standardized for such alphabet or language.

Having described a preferred embodiment of the invention, the following is claimed:

1. A keyboard for two hand operation by an operator, the keyboard comprising:
a housing including a front-facing surface and a rear-facing surface;
a plurality of keys located on the rear surface, the keys arranged into a first group and a second group, the first group and the second group of keys each including a plurality of multi-function keys, the plurality of multifunction keys adapted to provide a standard touch typing finger assignment for the fingers while the keyboard is held; and
a data channel connected to the keys.

2. The keyboard of claim 1 including a human readable display located on the front surface, the display viewable by the operator when the apparatus is held and while the multifunction keys on the rear facing surface are actuated.

3. The keyboard of claim 2 including a processor located within the housing, the processor in data communication with the keyboard and the display.

4. The keyboard of claim 1 including an Input/Output communications interface processor for providing the keyboard with network access using a least one of, a hardwired telecommunications connection, a fiber optic connection, a cellular phone connection, a satellite connection, an infrared connection, a cable television connection, an Internet connection and a radio connection.

5. The keyboard of claim 1 wherein the standard touch typing pattern is a QWERTY pattern.

6. The keyboard of claim 1 wherein each group of multifunction keys includes at least four keys.

7. The keyboard of claim 1 wherein the multifunction keys have at least a first actuating position providing a first character signal and a second actuating position providing a different second character signal.

8. The keyboard of claim 7 wherein at least one of the multifunction keys includes a third actuating position for providing a different third character signal.

9. The keyboard of claim 8 wherein at least one of the keys is actuatable to produce at least six different character signals.

10. The keyboard of claim 1 wherein each of the multifunction keys have at least a first actuating position providing a first character signal, a second actuating position providing a different second character signal third actuating position for providing a different third character signal.

11. The keyboard of claim 8 wherein at least one of the multifunction keys in each of the first and second group of keys is actuatable to produce at least six different character signals.

12. The keyboard of claim 10 wherein the standard touch typing finger assignments of the first and second group of keys is similar to the finger assignments for a QWERTY keyboard pattern.

13. The keyboard of claim 11 wherein at least one character signal is produced by multiple actuation of the key in at least one of the first, second and third actuating position.

14. A portable electronic apparatus comprising;
a housing including a front-facing surface and a rear-facing surface; and
at least two sets of multifunction keys located on the rear surface, each set including a plurality of multifunction keys, the multifunction keys adapted for touch typing using two hands while the apparatus is being held.

15. The apparatus of claim 14 including a human readable display retained in the front facing surface.

16. The apparatus of claim 14 wherein at least one of the keys has, a first actuating position for providing a first character, a second actuating position for providing a different second character and a third actuating position for providing a different third character.

17. A keyboard apparatus, the apparatus comprising:
a housing including a front facing surface and a rear facing surface; and
a first group of multifunction keys;
a second group of multifunction keys, the first and second groups of multifunction keys located on the rear facing surface, the first and second group of multifunction keys adapted for two handed touch typing according to a standard touch typing keyboard layout while the keyboard is held;
means for securably retaining the portable electronic device within the housing; and
means for data communication with the portable electronic device; and
means for interfacing the keyboard apparatus and portable electronic device with at least one of a telecommunications system, a fiber optic system, a cellular communications system, a satellite communications system, a cable television system, a computer system, an Internet access system and an infra red communications system.

18. The keyboard apparatus of claim 17 wherein the standard touch typing keyboard layout is a QWERTY layout.

19. The keyboard apparatus of claim 17 wherein each of the multifunction keys has, a first actuating position for providing a first character, a second actuating position for providing a different second character and a third actuating position for providing a different third character.

20. The keyboard apparatus of claim 17 wherein the first group of multifunction keys includes at least four multifunction keys and the second group of multifunction keys includes at least four multifunction keys.
